(19) United States
(12) Patent Application Publication
(10) Pub. No.: US 2011/0052889 A1
(43) Pub. Date: Mar. 3, 2011

(54) METHOD FOR PRODUCING A DECOR MATERIAL AND DECOR MATERIAL

(76) Inventor: Klaus Otto SCHMIDT, Potsdam (DE)

(21) Appl. No.: 12/827,785

(22) Filed: Jun. 30, 2010

(30) Foreign Application Priority Data
Sep. 1, 2009 (DE) 10 2009 039 531.8

(51) Int. Cl. B32B 5/16; B27N 3/14

(52) U.S. Cl. 428/207; 156/62.2

(57) ABSTRACT

The invention relates to a method for producing a decor material comprising a carrier material and a decor layer composed of sand particles which is formed thereon, wherein the method comprises the following steps: providing a container (1) which has a viewing wall section (3) and a container volume (2) to be filled, in such a way that the container volume (2) to be filled can be at least partially seen from outside through the viewing wall section (3), at least partially filling the container volume (2) of the container (1) with a quantity of sand, exposing a surface region of the filled quantity of sand, adhering sand particles of the filled quantity of sand to a carrier material by arranging flat on the exposed surface region the carrier material which is provided with an adhesive medium, and separating the carrier material with the adhering sand particles from the surface region. The invention also relates to a decor material.

### BACKGROUND OF THE INVENTION

Decor materials are known for example as stone veneers or stone decor. For these, a cleavable stone material is adhesively arranged as a thin decor layer on a carrier material. For example, the document DE 20 2007 016 153 U1 discloses a surface decor coating composed of a sandstone veneer on a door leaf.

The thin layer of stone is difficult to produce. In addition, the number of stone materials that can be processed in this way as a decor material is limited.

### SUMMARY OF THE INVENTION

The object of the invention is to provide a method for producing a decor material and also a decor material, with which the design and use possibilities of decor materials comprising a decor layer made from natural material are expanded.

This object is achieved according to the invention by a method for producing a decor material according to independent claim 1 and also a decor material according to independent claim 10. Advantageous embodiments of the invention form the subject matter of dependent claims.

According to one aspect of the invention, there is provided a method for producing a decor material comprising a carrier material and a decor layer composed of sand particles which is formed thereon, wherein the method comprises the following steps: providing a container which has a viewing wall section and a container volume to be filled, in such a way that the container volume to be filled can be at least partially seen from outside through the viewing wall section, at least partially filling the container volume of the container with a quantity of sand, exposing a surface region of the filled quantity of sand, adhering sand particles of the filled quantity of sand to a carrier material by arranging flat on the exposed surface region the carrier material which is provided with an adhesive medium, and separating the carrier material with the adhering sand particles from the surface region.

Another aspect of the invention relates to a decor material, produced by the above method, in which there is formed on a carrier material a decor layer composed of sand particles which adhere to the carrier material with the aid of an adhesive medium.

The invention encompasses the concept firstly of pouring a quantity of sand into a provided container, wherein the pouring process can be monitored through a viewing wall section of the container. Once the quantity of sand has been filled into the container in the desired manner, a surface region of the filled quantity of sand is exposed by preferably displacing at least one wall section of the container, for example the viewing wall section itself or a wall section which comprises the viewing wall section, for example by removing it or pushing it to one side. The viewing wall section may be a sub-section of a side wall of the container or an entire side wall. The material of the side wall section makes it possible at least partially to see therethrough the container volume to be filled. As materials, for example plastic materials or glass may be used for the viewing wall section.

During the production of the decor material, the carrier material is then placed onto the exposed surface region of the filled quantity of sand, wherein pressure is optionally applied in addition to the effect of the intrinsic weight of the carrier material. The applied carrier material is provided with an adhesive medium, so that sand particles of the filled quantity of sand in the exposed surface region adhere to the carrier material and also remain adhering thereto when the carrier material is finally separated once again from the surface region. The adhesive medium may be applied to the front and/or rear side of the carrier material. Various glues, which are known per se and can preferably be applied by brushing and/or spraying, may be used as the adhesive medium. The application of the adhesive medium may be carried out over some or all of the surface of the carrier material.

The decor layer composed of the sand particles is preferably produced with a thickness of around 2 mm to around 3 mm.

By means of the proposed technology, it is possible to produce in a desired manner decor materials in which the decor layer is formed of sand particles. The appearance of the decor layer is determined by the type of previously poured sand particles. There are therefore a large number of design possibilities for the decor layer formed of the sand particles on the carrier material. The options for varying the decor layer are independent of the natural existence of a stone. The complexity of producing a thin decor layer from natural stone is also circumvented.

Bulk packaging can then be provided by dividing the original decor material, for example by means of cutting.

As the carrier material, use is preferably made of nonwoven or woven materials for example. For this, use may be made of natural fibres, synthetic fibres or a mixture thereof.

The decor material produced is flexible and may have rounded sections and/or edges with a radius of less than around 3 mm. The decor material can be produced for example as a (sand) wallpaper. The material can be handled with little difficulty for example in architecture, trade fair construction or interior construction. The low weight and the flexibility are advantages over the known stone decors with natural stone layers. The production costs are also lower.

One preferred further development of the invention provides that, after separating the carrier material with the adhering sand particles from the surface region, at least one further carrier material which is provided with adhesive medium is arranged flat on the exposed surface region and then can be separated with adhering sand particles from the surface region. In this way, the originally poured volume of the filled quantity of sand is used multiple times for forming decor materials. Depending on the filled sand, therefore, decor materials having an identical or different decor layer can be produced, which depends on whether the filling with the sand particles in the container has an identical or non-identical sand particle composition throughout.

In one advantageous embodiment of the invention, it may be provided that the container, prior to exposing the surface region, is displaced from a filling position, in which the viewing wall section is arranged essentially upright, into a decor manufacturing position, in which the viewing wall section is arranged essentially not upright. In one embodiment, the viewing wall section in the filling position is arranged essentially perpendicular to the standing face of the container. One further development of the invention may provide in combination therewith or independently that the viewing wall section in the decor manufacturing position is arranged essentially horizontal to the standing face of the container.

One advantageous embodiment of the invention provides that, during the at least partial filling of the container volume, the quantity of sand is introduced into the container volume by means of a filling device and the filling device is in the process displaced on a guide device along an extension of the container volume. In this embodiment of the invention, it is possible to vary, in particular in a reproducible manner, the filling process with the sand particles along the extension of the container volume, that is to say for example in the longitudinal or transverse direction of the container. As the sand particles are dispensed into the container volume, the filling device is moved along the guide, which may also comprise a forward and backward movement, wherein the dispensing of the sand particles may take place only during the forward movement or only during the backward movement or even in both movement directions.

Preferably, one further development of the invention provides that the container volume is at least partially filled with a quantity of sand which comprises sand particles having different particle properties. Properties distinguishing the sand particles are for example the colour or the particle size. Sand particles having different particle properties make it possible to produce surface-area-dependent and/or volume-dependent property structures in the filled quantity of sand.

In one advantageous embodiment of the invention, it may be provided that, during the at least partial filling of the container volume, a coloured surface structure is formed in the region of the viewing wall section by means of the sand particles having the different particle properties. In addition or as an alternative, a different property structure may be formed in the region of the viewing wall section, for example in terms of the size of the sand particles.

One further development of the invention may provide that the coloured surface structure is formed in an essentially constant manner over the extension of the container volume in a direction perpendicular to the viewing wall section. In this way, it is possible in one embodiment of the invention to produce a plurality of decor materials by successively arranging a plurality of carrier materials on the filled quantity of sand, said decor materials having an essentially identical sand particle structuring in the surface. Superposed on the coloured surface structure or as an alternative thereto, a different property structuring for the sand particles may be formed in an essentially constant manner over the extension of the container volume in a direction perpendicular to the viewing wall section.

One preferred further development of the invention provides that, during the at least partial filling of the container volume, the sand particles having the different particle properties are released from separate dispensers of the filling device. Preferably, the plurality of dispensers are arranged one behind the other along the filling device. In this way, regions having different sand particle properties can be produced in a flexible manner during the filling of the container volume, said regions differing for example with regard to the colour of the sand particles and/or the size of the sand particles.

### DESCRIPTION OF PREFERRED EMBODIMENTS OF THE INVENTION

The invention will be explained below on the basis of preferred examples of embodiments and with reference to the figures of a drawing, in which:

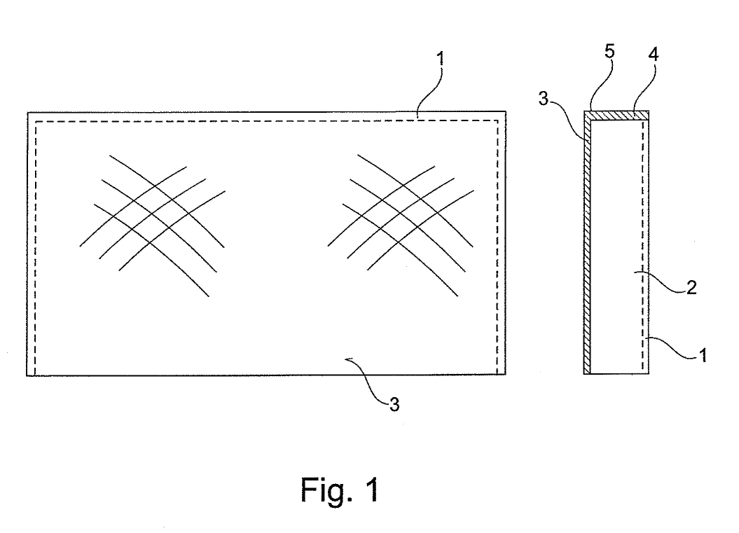

FIG. 1 shows a schematic diagram of a container for holding a quantity of sand, in a front and side view,

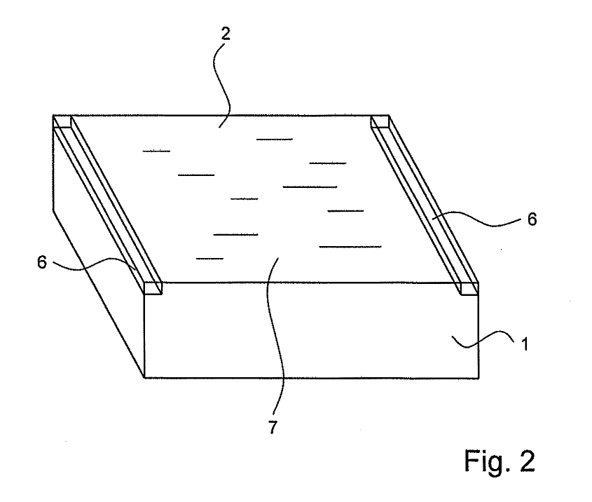

FIG. 2 shows a perspective diagram of the container of FIG. 1, wherein a viewing wall is removed,

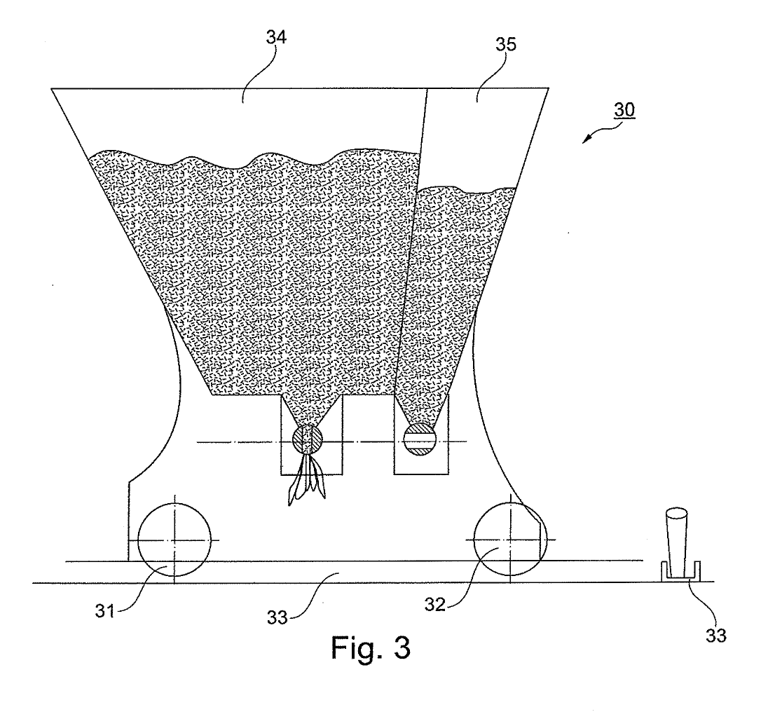

FIG. 3 shows a schematic diagram of a filling device for introducing a quantity of sand into a container, as shown for example in FIGS. 1 and 2, and

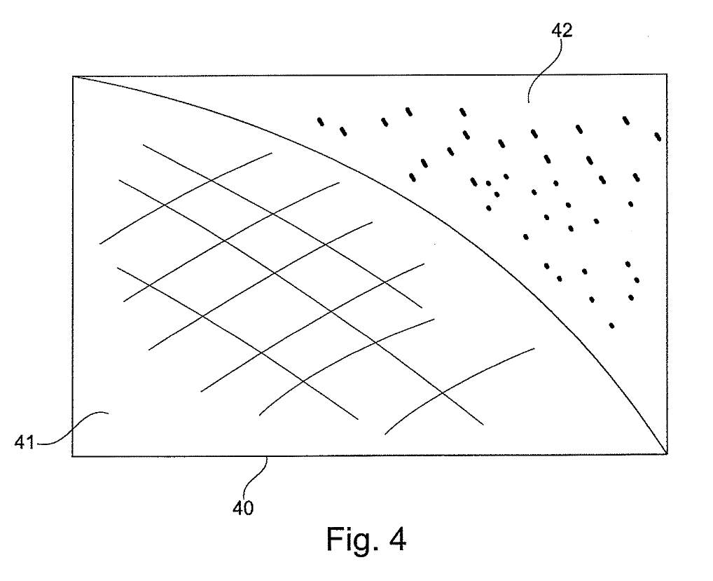

FIG. 4 shows a schematic diagram of a decor material, in which a decor layer composed of different sand particles is formed on a carrier material.

FIGS. 1 and 2 show schematic diagrams of a container 1, in which a container volume 2 that is to be filled with sand particles is formed. In FIG. 1, the container 1 is shown in a filling position, in which a transparent viewing wall 3 of the container 1 is arranged upright, said viewing wall being for example a wall section made from glass or an acrylic material.

In order to produce a decor material, the container 1 shown in FIG. 1 is at least partially filled with sand particles through a container opening 4 in the region of a narrow wall 5 of the container 1. The filling of the sand particles and the result of the filling process can be observed from outside through the viewing wall 3. In this way, the manner of filling the container volume 2 with the sand particles can be monitored.

Once the container volume 2 is filled with sand particles in the desired manner, the container 1 is laid down as shown in FIG. 2 and the viewing wall 3 is removed, which in the illustrated embodiment takes place by displacing the viewing wall 3 along guide grooves 6. In this way, a surface region 7 of the filled sand is exposed. A carrier material, for example a nonwoven or woven fabric (not shown) is then placed onto this surface region 7, said fabric being provided at least in sub-regions with an adhesive medium, for example in the form of a glue. In this way, sand particles adhere to the carrier material, as a result of which a decor layer composed of adhering sand particles is formed on the carrier material. In one embodiment, the carrier material with the sand particles adhering thereto can be removed after a drying time of around 20 to 30 minutes. FIG. 4 shows an example of such a decor layer 40, which is produced with sand particles of a first colour 41 and sand particles of a second colour 42.

The process of applying a carrier material provided with an adhesive medium and then removing it can be repeated multiple times. If the design of the sand filling in the container 1 is essentially uniform over the depth, decor materials having an essentially identical decor layer are produced one after the other.

1. A method for producing a decor material comprising a carrier material and a decor layer composed of sand particles which is formed thereon, wherein the method comprises the following steps:
providing a container which has a viewing wall section and a container volume to be filled, in such a way that the container volume to be filled can be at least partially seen from outside through the viewing wall section,
at least partially filling the container volume of the container with a quantity of sand,
exposing a surface region of the filled quantity of sand,
adhering sand particles of the filled quantity of sand to a carrier material by arranging flat on the exposed surface region the carrier material which is provided with an adhesive medium, and
separating the carrier material with the adhering sand particles from the surface region.

2. The method according to claim 1, wherein after separating the carrier material with the adhering sand particles from the surface region, at least one further carrier material which is provided with adhesive medium is arranged flat on the exposed surface region and then is separated with the adhering sand particles from the surface region.

3. The method according to claim 1, wherein the container, prior to exposing the surface region, is displayed from a filling position, in which the viewing wall section is arranged essentially upright, into a decor manufacturing position, in which the viewing wall section is arranged essentially not upright.

4. The method according to claim 1, wherein during the at least partial filling of the container volume, the quantity of sand is introduced into the container volume by a filling device and the filling device is in the process displaced on a guide device along an extension of the container volume.

5. The method according to claim 1, wherein the container volume is at least partially filled with a quantity of sand which comprises sand particles having different particle properties.

6. The method according to claim 5, wherein during the at least partial filling of the container volume, a coloured surface structure is formed in the region of the viewing wall section by of the sand particles having the different particle properties.

7. The method according to claim 6, wherein the coloured surface structure is formed in an essentially constant manner over the extension of the container volume in a direction perpendicular to the viewing wall section.

8. The method according to claim 5, wherein during the at least partial filling of the container volume, the sand particles having the different particle properties are released from separate dispensers of the filling device.

9. The method according to claim 1, wherein a nonwoven material is used as the carrier material.

10. A decor material comprising a carrier material and a decor layer composed of sand particles, produced by a method comprising the steps of:
providing a container which has a viewing wall section and a container volume to be filled, in such a way that the container volume to be filled can be at least partially seen from outside through the viewing wall section,
at least partially filling the container volume of the container with a quantity of sand,
exposing a surface region of the filled quantity of sand,
adhering sand particles of the filled quantity of sand to a carrier material by arranging flat on the exposed surface region the carrier material which is provided with an adhesive medium, and
separating the carrier material with the adhering sand particles from the surface region,
wherein the decor layer is formed on the carrier material and the sand particles adhere to the carrier material with the aid of an adhesive medium.

11. The method according to claim 2, wherein the container, prior to exposing the surface region, is displayed from a filling position, in which the viewing wall section is arranged essentially upright, into a decor manufacturing position, in which the viewing wall section is arranged essentially not upright.
